(19) United States
(12) Patent Application Publication
(10) Pub. No.: US 2024/0311036 A1
(43) Pub. Date: Sep. 19, 2024

(54) CONFIGURING ERASE BLOCKS COUPLED TO A SAME STRING AS ZONES

(71) Applicant: Micron Technology, Inc., Boise, ID (US)

(72) Inventors: Daniel J. Hubbard, Boise, ID (US); Kishore K. Muchherla, San Jose, CA (US); Dave Ebsen, Minnetonka, MN (US); Akira Goda, Setagaya (JP)

(21) Appl. No.: 18/606,742

(22) Filed: Mar. 15, 2024

Related U.S. Application Data
(60) Provisional application No. 63/452,493, filed on Mar. 16, 2023.

(51) Int. Cl. G06F 3/06

(52) U.S. Cl. CPC G06F 3/0652; G06F 3/0604; G06F 3/064; G06F 3/0688

(57) ABSTRACT

An apparatus can comprise a memory array comprising a plurality of strings of memory cells. Each string of the plurality of strings comprises: a first group of memory cells coupled to a first group of access lines and corresponding to a first erase block; and a second group of memory cells coupled to a second group of access lines and corresponding to a second erase block. The first erase block can be configured as a first zone of one or more zones corresponding to a namespace independently of the second erase block.

This application claims the benefits of U.S. Provisional Application No. 63/452,493, filed on Mar. 16, 2023, the contents of which are incorporated herein by reference.

### TECHNICAL FIELD

Embodiments of the disclosure relate generally to memory systems, and more specifically, relate to apparatuses and methods for configuring erase block coupled to a same string as zones.

### BACKGROUND

A memory system can include a memory sub-system, which can be a storage device, a memory module, or a hybrid of a storage device and a memory module. Examples of a storage device include a solid-state drive (SSD), a Universal Flash Storage (UFS) drive, a secure digital (SD) card, an embedded Multiple Media Card (eMMC), and a hard disk drive (HDD). Examples of memory modules include a dual in-line memory module (DIMM) and various types of non-volatile dual in-line memory modules (NVDIMMs). Memory systems include one or more memory components (e.g., memory devices) that store data. The memory components can be, for example, non-volatile memory components (e.g., NAND flash memory devices) and volatile memory components (e.g., DRAM devices). In general, a host system can utilize a memory system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example portion of a memory system including a memory device having and array in accordance with various embodiments of the present disclosure.

FIG. 2 is a schematic diagram illustrating an example memory array in accordance with various embodiments of the present disclosure.

FIG. 3 schematically illustrates a portion of a memory array having multiple erase blocks per string in accordance with various embodiments of the present disclosure.

FIG. 4 illustrates a portion of a memory array having multiple erase blocks per string in accordance with various embodiments of the present disclosure.

FIG. 5 illustrates a portion of a memory device (e.g., a memory array) organized as multiple logical units and super decks having multiple erase blocks over different planes in accordance with various embodiments of the present disclosure.

FIG. 6 illustrates example configurations, in which a portion of a memory device can be configured as multiple zones in accordance with various embodiments of the present disclosure.

FIG. 7 illustrates an example computing system having a memory system for configuring erase blocks coupled to a same string as zones in accordance with various embodiments of the present disclosure.

### DETAILED DESCRIPTION

Aspects of the present disclosure are directed to apparatuses and for configuring erase blocks coupled to a same string as zones. Various types of memory, such as NAND flash memory, include a memory array of many memory cells that can be arranged in row and column fashion and grouped in physical blocks. The cells can be floating gate transistors that can be programmed to store one more bits by adding charge to the floating gate. Generally, an erase operation (e.g., a “block erase”) is performed to erase all of the cells of a block together as a group.

Three-dimensional (3D) flash memory (e.g., a 3D NAND memory array) can include multiple strings of memory cells with each string comprising multiple series-coupled (e.g., source to drain) memory cells in a vertical direction, with the memory cells of a string sharing a common channel region. Each memory cell of a string can correspond to a different tier of the memory array, with a group of strings sharing multiple access lines, which may be referred to as word lines (WLs). Each access line can be coupled to respective memory cells of each string in the group of strings (e.g., the memory cells of a particular tier of the memory array). Groups of strings are coupled to respective sense lines, which may be referred to as data lines or bit lines (BLs), of a group of sense lines. The cells of the strings can be positioned between a drain-side select gate (referred to as a select gate drain (SGD)) and a source-side select gate (referred to as select gate source (SGS)) used to control access to the strings. A 3D memory array can comprise multiple blocks each comprising a plurality of memory pages (e.g., physical pages of cells than can store one or more logical pages of data).

Further, NAND memory devices (e.g., including a 3D NAND memory array) can be configured as a zoned namespace (ZNS), which can include one or more zones. Zones can be respectively designated for memory operations (e.g., garbage collection, deallocation, etc.) requested by the host system. In various previous approaches, a physical block of memory cells corresponds to a smallest group of memory cells that can be independently erased. For example, in prior approaches it is not possible to erase some of the memory cells of a block while maintaining data in other memory cells of the block. Therefore, in those prior approaches, a physical block is necessarily a smallest unit that can be independently configured as a zone, which can limit performance and power efficiency in accessing a zone to performance and power efficiency in accessing a single block at most.

Various embodiments of the present disclosure address the above and other deficiencies by providing apparatus and methods that can independently configure each one of multiple erase blocks coupled to a same string and having a smaller size than a block size as part of zones. As used herein, an “erase block” refers to a group of cells that are configured to be erased together as a group and that share a same string as one or more additional groups of cells (e.g., one or more additional erase blocks). An erase block may also be referred to as a “deck.” Being able to configure each erase block independently as part of zones can further provides a capability of utilizing more planes (e.g., which can be substantially simultaneously accessed) in configuring zones to improve performance and power efficiency as compares to the prior approaches. For example, while a zone having a block size (e.g., a size corresponding to a single physical block) necessarily had to be built solely based on a single physical block (that is on a single plane) in those prior approaches, a zone having the same size can be built based on two erase blocks that are distributed over two different planes in various embodiments of the present disclosure, which can improve performance and power efficiency by not necessarily limiting performance and power efficiency in accessing a zone to performance and power efficiency in accessing a single block.

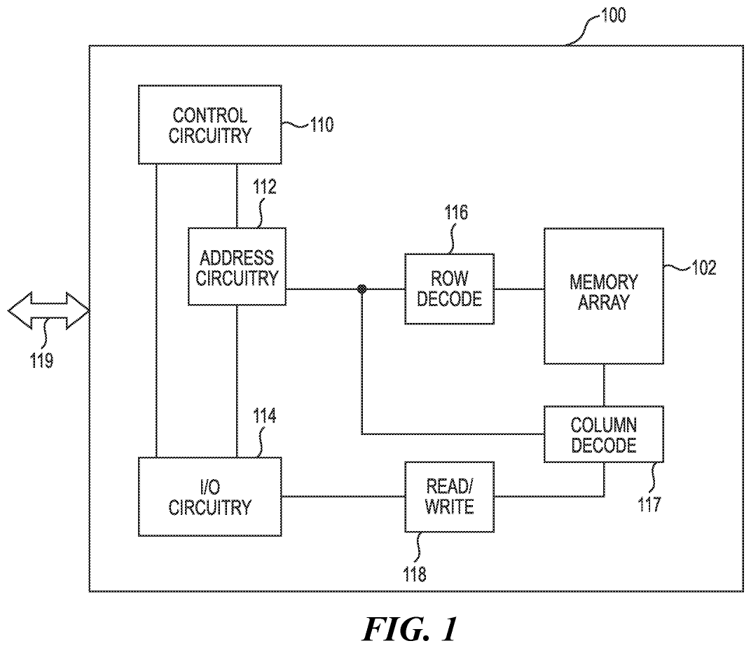

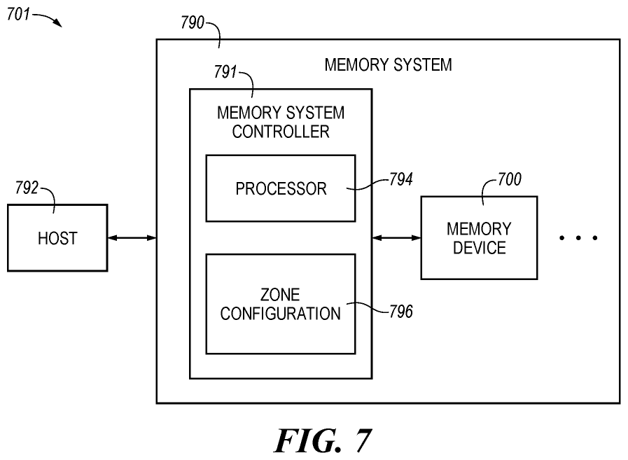

FIG. 1 illustrates an example portion of a memory system including a memory device 100 having and array 102 in accordance with various embodiments of the present disclosure. The memory device 100 can be part of a memory system such as memory system 790 described in FIG. 7.

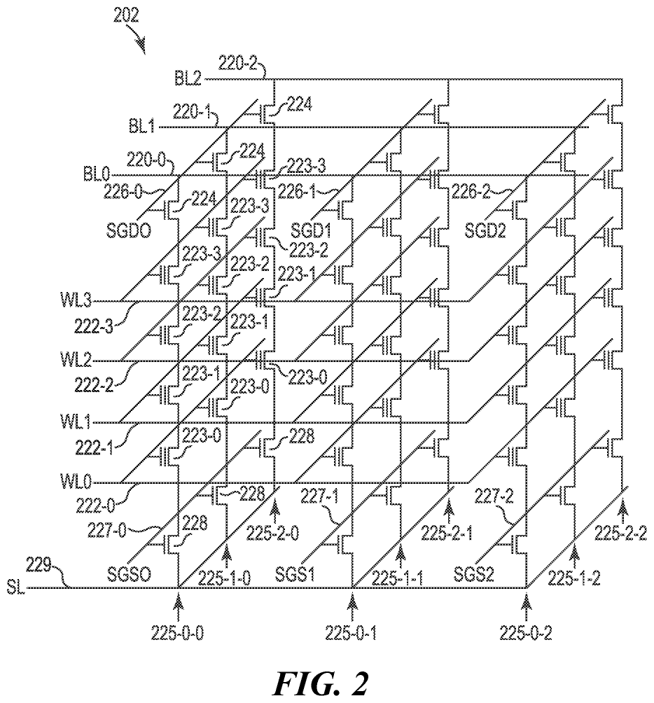

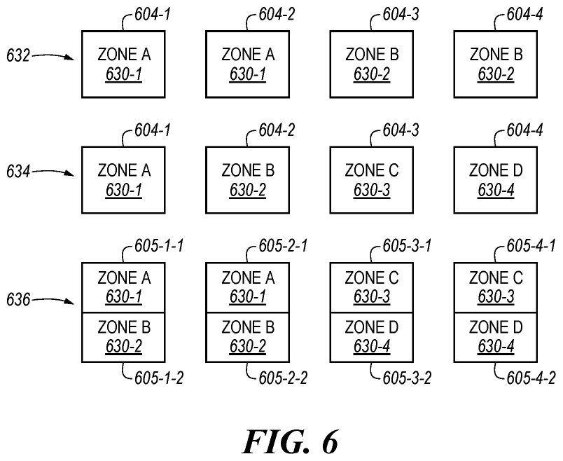

The memory array 102 can be a 3D NAND array such as described further in association with FIG. 2, for example. The array can comprise single level cells (SLCs) storing 1 bit per cell, multilevel cells (MLCs) storing 2 bits per cell, triple level cells (TLCs) storing three bits per cell, or quad level cells (QLCs) storing 4 bits per cell, for example. Embodiments are not limited to a particular type of memory cell. The memory array 102 can be configured as a zoned namespace that includes multiple zones (e.g., zones 630 illustrated in FIG. 6). As further illustrated herein, each erase block of the memory array 102 can be independently configured as one or more zones of the namespace. Further details of how memory arrays (e.g., memory array 102) can be configured as zones are illustrated in FIG. 6.

The memory device 100 includes control circuitry 110, address circuitry 112, input/output (I/O) circuitry 114 used to communicate with an external device via an interface 119, which may be a bus used to transmit data, address, and control signals, among other signals between the memory device 100 and an external host device, which can include a controller, host processor, etc., that is capable of accessing the memory array 102. The interface 119 can include a combined address, control, and data bus or separate busses depending on the particular physical interface and corresponding protocol. The interface 119 can be an Open NAND Flash Interface (ONFI) interface or a Non-Volatile Memory Express (NVMe) interface; however, embodiments are not limited to a particular type of interface or protocol.

The control circuitry 110 can decode signals (e.g., commands) received via interface 119 and executed to control operations performed on the memory array 102. The operations can include data programming operations, which may be referred to as write operations, data read operations, which may be referred to as sensing operations, data erase operations, etc. The control circuitry 110 can cause various groups of memory cells (e.g., pages, blocks, erase blocks, etc.) to be selected or deselected in association with performing memory operations on the array 102. The control circuitry 110 can comprise a state machine, a sequencer, and/or some other type of control circuitry, which may be implemented in the form of hardware, firmware, or software, or any combination thereof.

The I/O circuitry 114 is used for bi-directional communication of data between the memory array 102 and the external host via interface 119. The address circuitry 112, which can include a register, can latch address signals received thereto, and the address signals can be decoded by a row decoder 116 and a column decoder 117 to access the memory array 102. The memory device 100 includes read/write circuitry 118 used to read data from and write data to the memory array 102. As an example, the read/write circuitry can include various latch circuitry, drivers, sense amplifiers, buffers, etc. Data can be read from the memory array 102 by sensing voltage and/or current changes on bit lines of the memory array 102.

FIG. 2 is a schematic diagram illustrating an example memory array 202 in accordance with various embodiments of the present disclosure. The memory array 202 can be located in a memory device such as memory device 100 described in FIG. 1, for example. The memory array 200 is a 3D NAND array.

The memory array 200 comprises a number of access lines (word lines) 222-0 (WL0), 222-1 (WL1), 222-2 (WL2), and 222-3 (WL3) and a number of sense lines (bit lines) 220-0 (BL0), 220-1 (BL1), and 220-2 (BL2) coupled to multiple strings 225-0-0, 225-0-1, 225-0-2, 225-1-0, 225-1-1, 225-1-2, 225-2-0, 225-2-1, and 225-2-2. The word lines, bit lines, and strings are collectively referred to as word lines 222, bit lines 220, and strings 225, respectively. Although four word lines 222, three bit lines 220, and nine strings 225 are shown, embodiments are not so limited.

Each of the strings 225 comprises a number of memory cells (referred to collectively as memory cells 223) located between a select transistor 224 and a select transistor 228. For example, as shown in FIG. 2, strings 225-0-0, 225-1-0, and 225-1-2 each respectively comprise memory cells 223-0, 223-2, 223-2, and 223-3 located between select transistors 224 and 228 (e.g., respective drain-side select gate (SGD) 224 and source-side select gate (SGS) 228). The memory cells 223 can be floating gate transistors with the cells 223 of a given string 225 sharing a common channel region (e.g., pillar). As shown, the memory cells 223 of a given string are series-coupled source to drain between the SGD transistor 224 and the SGS.

The memory cells 223 of the strings 225 are stacked vertically such that they are located on distinct tiers/levels of the memory array 202. Each word line 222 can be commonly coupled to all the memory cells at a particular tier/level. For example, word line 222-0 can be coupled to (e.g., as the control gate) the nine memory cells 223-0 corresponding to the nine respective strings 225.

The select gate transistors 224 and 228 can be controlled (e.g., turned on/off) via the corresponding select gate signals SGD0, SGD1, SGD2, SGS0, SGS1, and SGS2 in order to couple the strings 225 to their respective bit lines 220 and a common source line (SL) 229 during memory operations (e.g., reads, writes, erases). As shown in FIG. 2, the select gate signals SGD0, SGD1, and SGD2 are provided (e.g., to the gates of transistors 224) via respective conductive lines 226-0, 226-1, and 226-2, and the select gate signals SGS0, SGS1, and SGS2 are provided (e.g., to the gates of transistors 228) via respective conductive lines 227-0, 227-1, and 227-2. Although the signals SGS0, SGS1, and SGS2 are shown on separate conductive lines 227, in some embodiments the conductive lines 227-0, 227-1, and 227-2 may be coupled via a common SGS line.

To perform memory operations on the array 202, particular voltages can be applied to the word lines 222, bit lines 220, and source line 229. The particular voltages applied depends on the memory operation being performed, and different voltages may be applied to the word lines 222 during a particular memory operation in order to store data in a cell (or page of cells) or read data from a cell. For example, a write operation to store data in a selected memory cell 223-2 of string 225-0-0 (shown within a dashed circle) selected to store information into memory cell 212 can involve applying a voltage (e.g., a programming voltage) to the word line 222-2 corresponding to the selected cell 223-2 and other voltages to the word lines (222-0, 222-1, and 222-3) coupled to non-selected cells (222-0, 222-1, and 222-4) (e.g., the memory cells not being programmed). An erase operation to remove data from a selected group of memory cells (e.g., a selected erase block as described further below) can include applying a relatively high voltage (e.g., 20V) to the source line 229, the relatively high voltage (e.g., 20V) to unselected word lines (e.g., word lines coupled to cells of an erase block not being erased), and a relatively low voltage (e.g., 0V) to the selected word lines (e.g., the word lines coupled to the erase block being erased), which results in erasing of the cells of the selected erase block by removing charge from their floating gates and thereby reducing their Vt levels to near 0V, for example.

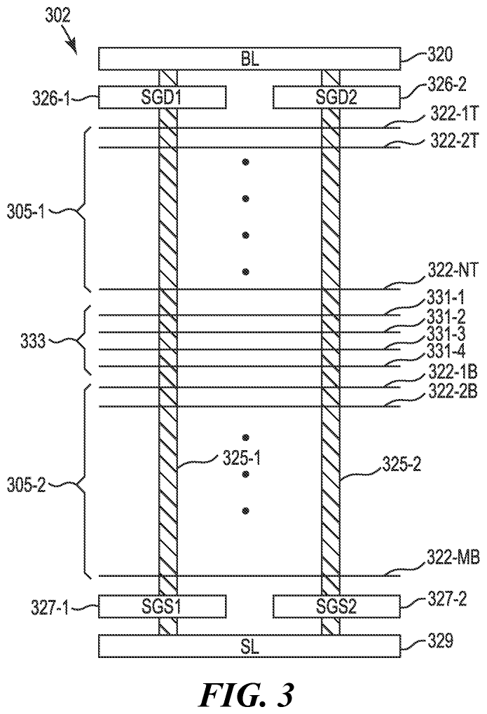

As described further in FIG. 3, the memory cells 223 of the array 202 can represent a physical block of memory cells that can comprise multiple (e.g., two or more) physical erase blocks. As an example, the word lines 222-0 and 222-1 can be coupled to cells of a first erase block, and the word lines 222-2 and 222-3 can be coupled to cells of a second/different erase block. Therefore, the cells 223-0 and 223-1 of the nine respective strings 225 (e.g., the cells of the first erase block) share respective common strings with the cells 223-2 and 223-3 (e.g., the cells of the second erase block).

As further described herein, an array (e.g., 202) can comprise a number of word lines physically between (e.g., separating) the word lines (e.g., 222) corresponding to different erase blocks. The word lines separating word lines corresponding to different erase blocks can be referred to as “dummy” word lines and can be coupled to dummy memory cells (e.g., within the strings 225) that are not used to store data. The dummy word lines and/or dummy cells can facilitate the ability to perform erase operations separately on erase blocks that share a common string or strings. The quantity of dummy word lines between erase blocks can vary, and various bias voltages can be applied to the dummy word lines during the various memory operations performed on the erase blocks.

In operation, erase blocks can be separately (e.g., individually) selected or deselected. For example, an erase operation can be performed on a selected first erase block corresponding to a group of strings while other erase block(s) corresponding to the same group of strings is deselected (e.g., such that is not erased).

FIG. 3 schematically illustrates a portion of a memory array 302 having multiple erase blocks per string in accordance with various embodiments of the present disclosure. The example shown can be a portion of the array 202 described in FIG. 2. The array portion 302 can be a portion of a physical block of memory cells that includes multiple erase blocks (e.g., decks).

In this example, the array 302 includes a plurality/group of word lines 322-1T, 322-2T, . . . , 322-NT corresponding to a first erase block 305-1 (e.g., a top deck) and a plurality/group of word lines 322-1B, 322-2B, . . . , 322-MB corresponding to a second erase block 305-2 (e.g., bottom deck). The designators “N” and “M” can represent various numbers (e.g., 3 or more) and “N” and “M” can be the same number. Accordingly, embodiments are not limited to a particular quantity of word lines 322 for the top deck 305-1 or bottom deck 305-2 (the designator “T” corresponding to “top” and the designator “B” corresponding to “bottom”). The array 302 also includes a number of dummy word lines 331-1, 331-2, 331-3, and 331-4, which can be collectively referred to as word lines 331. The dummy word lines 331 correspond to a separation region 333 between the top deck 305-1 and bottom deck 305-2. Although four word lines 331 are illustrated, embodiments can include more or fewer than four dummy word lines 331 separating erase blocks corresponding to same strings.

The array portion 304 illustrates two strings 325-1 and 325-2 for ease of illustration; however, embodiments can include many more strings 325. Memory cells are located at the intersections of the word lines 322/331 and strings 325, with the memory cells of a particular string 325 sharing a common channel region (e.g., pillar) as described in FIG. 2. The dummy word lines 331 can be coupled to dummy memory cells (e.g., cells that are not addressable to store user data).

As illustrated in FIG. 3, a first end of the strings 325-1 and 325-2 can be coupled to a common source line 329 via respective select gate source lines 327-1 (SGS1) and 327-2 (SGS2). The second/opposite end of the strings 325-1 and 325-2 can be coupled to a bit line 320 via respective select gate drain lines 326-1 (SGD1) and 326-2 (SGD2). As such, the strings 325 (e.g., the cells thereof) can be individually accessed using the bit line 320 and select gates to which the lines 326-1 and 326-2 are coupled. Although only a single bit line 320 is shown, embodiments can include multiple bit lines such as shown in FIG. 2, for example.

As noted herein, in various embodiments, the top deck 305-1 and the bottom deck 305-2 can be erased via separate erase operations even though the cells of the decks 305-1/305-2 share the same strings 325-1/325-2. For example, an erase operation can be performed on the cells coupled to word lines 322-IT to 322-NT without erasing the cells coupled to the word lines 322-1B to 322-MB, and vice versa. Similarly, each one of the decks 305-1 and 305-2 can be individually programmed and/or read without programming or reading the other of the decks 305-1 and 305-2. An erase operation performed on a selected deck 305-1, for example, can include applying relatively low voltages to the selected word lines 322-1T to 322-NT, while applying relatively high voltages to the word lines 322-1B to 322-1M of the unselected deck 305-2.

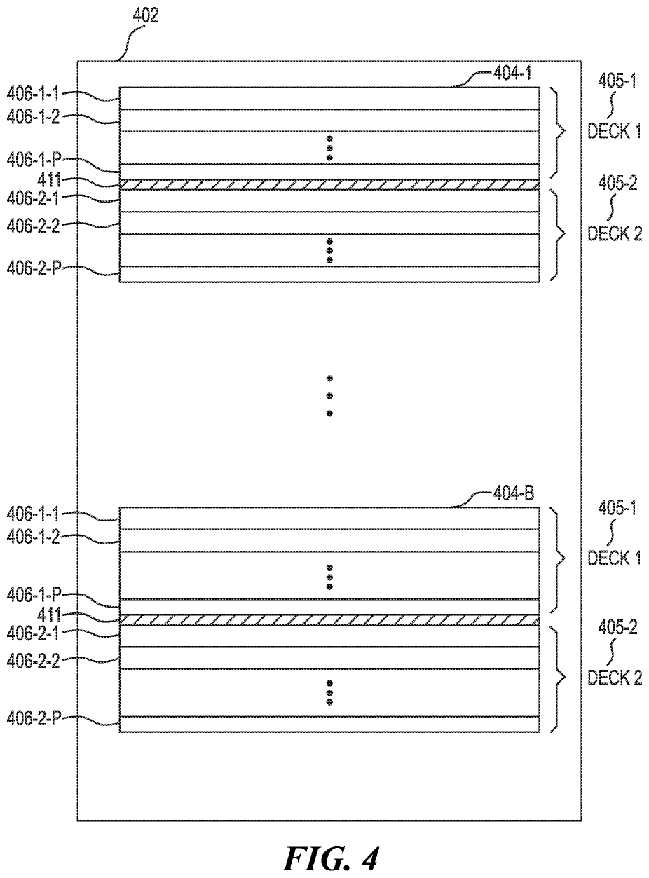

FIG. 4 illustrates a portion of a memory array 402 having multiple erase blocks per string in accordance with various embodiments of the present disclosure. The memory array 402 includes multiple physical blocks 404-1, . . . , 404-B and can be operated in accordance with one or more embodiments of the present disclosure. The indicator “B” is used to indicate that the array 402 can include a number of physical blocks 404. As an example, the number of physical blocks in array 402 can be 128 blocks, 512 blocks, or 1,024 blocks, but embodiments are not limited to a particular multiple of 128 or to any particular number of physical blocks in an array 402. The memory array 402 can be, for example, a NAND flash memory array (e.g., a 3D NAND flash array such as array 102, 202, and/or 302).

Each of the physical blocks 404-1, . . . , 404-B includes a first erase block 405-1 (DECK_1) and a second erase block 405-2 (DECK_2) separated by a region 411, which can correspond to a region of dummy word lines such as word lines 331 shown in FIG. 3. As described above, the decks 405-1 and 405-2 are commonly coupled to the strings of the blocks 404-1, . . . , 404-B with the decks 405-1 and 405-2 being separately erasable via a block erase operation (e.g., deck 405-1 can be erased without erasing deck 405-2 and vice versa).

Each deck 405-1 and 405-2 can comprise a number of physical pages, which can correspond to a “row” of the array corresponding to a particular word line. As shown, deck 405-1 comprises pages 406-1-1, 406-1-2, . . . , 406-1-P, and deck 405-2 comprises pages 406-2-1, 406-2-2, . . . , 406-2-P. The designator “P” is used to indicate that the decks 405-1 and 405-2 can comprise a plurality of pages/rows. Each physical page (collectively referred to as pages 406) can store multiple logical pages of data. A page can refer to a unit of programming and/or reading (e.g., a group of cells that are programmed and/or read together as a functional group).

Each erase block 405 can be independently configured as part of one or more zones (e.g., zones 630 illustrates in FIG. 6). For example, the first erase block 405-1 of the physical block 404-1 can be configured as a first zone, while the second erase block 405-2 of the physical block 404-1 can be configured as not being part of the first zone. In this example, the second erase block 405-2 can be configured as a second zone that is different than the first zone comprising the first erase block 405-1. Accordingly, multiple erase blocks of a same physical block can be independently configured as different zones.

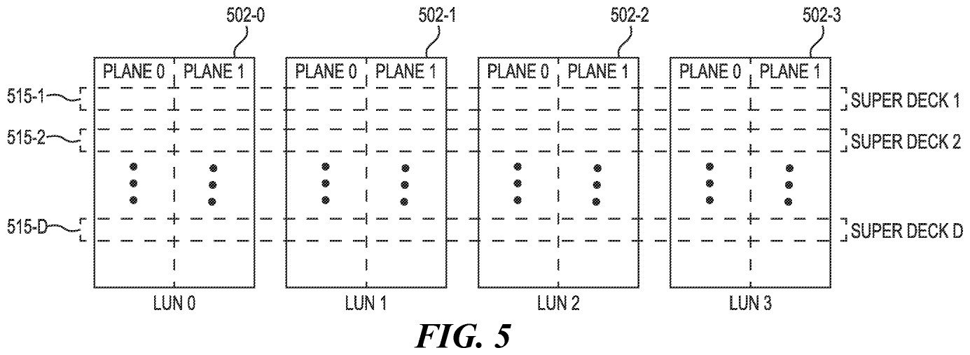

FIG. 5 illustrates a portion of a memory device (e.g., a memory array) organized as multiple logical units and super decks having multiple erase blocks over different planes in accordance with various embodiments of the present disclosure. In various embodiments, the physical blocks of a memory array can be organized into planes. For example, FIG. 5 illustrates memory arrays 502-0, 502-1, 502-3, and 502-4 each divided into a first plane (PLANE 0) of physical blocks and a second plane (PLANE 1) of physical blocks. Embodiments are not limited to a particular quantity of planes per array. Each array 502-0, 502-1, 502-3, and 502-4 corresponds to a respective logical unit (LUN) LUN0, LUN1, LUN2, and LUN3. Each LUN can correspond to a different memory device (e.g., memory device 100 shown in FIG. 1); however, embodiments are not so limited. For example, a memory device (e.g., die) can include multiple LUNs. Commands can be executed at each LUN one at a time.

The physical blocks of the planes can comprise multiple erase blocks sharing common strings as described herein. The physical blocks can be grouped into “super blocks” with each super block comprising a physical block from each plane (e.g., PLANE 0 and PLANE 1) across multiple LUNs (e.g., across multiple arrays 502). Similarly, embodiments of the present disclosure an include a number of super decks 515-1 (SUPER DECK_1), 515-2 (SUPER DECK_2), . . . , 515-D (SUPER DECK_D). Each super deck (or super erase block) 515 can comprise a deck from each plane across multiple LUNs. For example, a first super deck 515-1 (SUPER DECK_1) can comprise a deck from plane 0 of LUN0, a deck from plane 1 of LUN1, a deck from plane 0 of LUN1, a deck from plane 1 of LUN1, a deck from plane 0 of LUN2, a deck from plane 1 of LUN2, a deck from plane 0 of LUN3, and a deck from plane 1 of LUN3.

Memory cells (e.g., blocks and/or erase blocks) of different planes (e.g., of a same LUN or different LUNs) can be accessed substantially simultaneously. As used herein, the term “substantially” means that the characteristic need not be absolute, but is close enough so as to achieve the advantages of the characteristic. For example, “substantially simultaneously” is not limited to operations that are performed absolutely simultaneously and can include timings that are intended to be contemporaneous but due to various limitations (e.g., manufacturing limitations) may not be precisely simultaneously.

FIG. 6 illustrates example configurations 632, 634, 636, in which a portion of a memory device can be configured as multiple zones 630-1, 630-2, 630-3, 630-4 (collectively referred to as zones 630) in accordance with various embodiments of the present disclosure. The planes (e.g., PLANE 0, PLANE 1, PLANE 2, PLANE 3) can be included in one or more memory arrays (e.g., memory arrays 502-0, . . . , 502-3 illustrated in FIG. 5) in various manners. In one example, a memory array can be a two-plane memory array (e.g., die) such that PLANE 0 and PLANE 1 can be included in the same memory array, while PLANE 2 and PLANE 3 can be included in a different memory array. In another example, a memory can be a four-plane memory array (e.g., die) such that PLANE 0, PLANE 1, PLANE 2, PLANE 3 are included in the same memory array. As illustrated in FIG. 5, each memory array can be independently configured as a respective LUN (e.g., LUN0, LUN1, LUN2, and LUN3 illustrated in FIG. 5), although embodiments are not so limited.

In a configuration 632 illustrated in in FIG. 6, two physical blocks 604-1 and 604-2 are configured as a zone “A” and two physical blocks 604-3 and 604-4 are configured as a zone “B”. Accordingly, each zone (e.g., zone “A” or “B”) can have a size corresponding to two physical blocks.

In a configuration 634 illustrated in in FIG. 6, each physical block 604-1, . . . , 604-4 is configured as a respective zone. For example, a physical block 604-1 is configured as a zone “A”, a physical block 604-2 is configured as a zone “B”, a physical block 604-3 is configured as a zone “C”, and a physical block 604-4 is configured as a zone “D”. Accordingly, each zone (e.g., zone “A”, “B”, “C”, or “D”) can have a size corresponding to a single physical block.

In a configuration 636 illustrated in FIG. 6, a top deck 605-1-1 of a physical block 604-1 and a top deck 605-1-2 of a physical block 604-2 are configured as a zone “A”, while a bottom deck 605-2-1 of the physical block 604-1 and a bottom deck 605-2-2 of the physical block 604-2 are configured as a different zone “B”. For example, as illustrated in FIG. 6, a top deck 605-1-3 of a physical block 604-3 and a top deck 605-1-4 of a physical block 604-4 are configured as a zone “C”, while a bottom deck 605-2-3 of the physical block 604-3 and a bottom deck 605-2-4 of the physical block 604-4 are configured as a different zone “D”. Accordingly, each zone (e.g., zone “A”, “B”, “C”, or “D”) can have a size corresponding to a single physical block. Top and bottom decks illustrated in association with the configuration 636 and are in a same physical block can be coupled to same strings 225 and/or 325 respectively illustrated in FIGS. 2-3. For example, top and bottom decks 605-1-1 and 605-1-2 can be coupled to same stings; top and bottom decks 605-2-1 and 605-2-2 can be coupled to same stings; top and bottom decks 605-3-1 and 605-3-2 can be coupled to same stings; and top and bottom decks 605-4-1 and 605-4-2 can be coupled to same stings.

As illustrated in association with the configuration 636, being capable of configuring each erase block (that is smaller than a physical block in terms of size) independently as part of the respective zone (e.g., zone “A”, “B”, “C”, or “D”) can provide benefits, such as being capable of utilizing more quantity of planes for each zone. For example, while zones illustrated in association with the configurations 634 and 636 have a same size (e.g., corresponding to a block size), each zone illustrated in association with the configuration 636 is distributed over two planes, while each zone illustrated in association with the configuration 634 is built solely based on a single block and a single plane. Accordingly, each zone illustrated in association with the configuration 636 can be accessed by accessing two planes substantially simultaneously, while such access is not feasible in accessing each zone illustrated in association with the configuration 634.

FIG. 7 illustrates an example computing system 701 having a memory system 790 for configuring erase blocks coupled to a same string in accordance with various embodiments of the present disclosure. As shown in FIG. 7, the memory system 790 includes a system controller 791 and a number of memory devices 700, which can be memory devices such as device 100 described in FIG. 1 (e.g., memory devices comprising memory arrays having multiple erase blocks coupled to common strings).

In some embodiments, the memory system 790 is a storage system. An example of a storage system is a solid-state drive (SSD). In some embodiments, the memory system 790 is a hybrid memory/storage sub-system. In general, the computing environment shown in FIG. 7 can include a host system 792 that uses the memory system 790. For example, the host system 792 can write data to the memory system 790 and read data from the memory system 790.

The memory system controller 791 (hereinafter referred to as “controller”) can communicate with the memory devices 700 to perform operations such as reading data, writing data, or erasing data at the memory devices 700 and other such operations. The controller 791 can include hardware such as one or more integrated circuits and/or discrete components, a buffer memory, or a combination thereof. The controller 700 can include a microcontroller, special purpose logic circuitry (e.g., a field programmable gate array (FPGA), an application specific integrated circuit (ASIC), etc.), or other suitable processing circuitry. The controller 700 can include a processing device (e.g., processor 794) configured to execute instructions stored in local memory (not shown).

In this example, the controller 791 includes a zone configuration component 796 that can be responsible for configuring memory device with one or more zones as described herein. For example, with each erase block (e.g., erase block 305 and/or 405 respectively illustrated in FIGS. 3-4) being a smallest unit that can be independently configured as part of one or more zones (e.g., zones 630 illustrated in FIG. 6), the zone configuration component 796 can configure memory cells of various locations of the memory device 700 as zones and report the configuration to the host 792.

In general, the controller 791 can receive commands or operations from the host system 792 and can convert the commands or operations into instructions or appropriate commands to achieve the desired access to the memory devices 700. The controller 791 can be responsible for other operations such as wear leveling operations, garbage collection operations, error detection and error-correcting code (ECC) operations, encryption operations, caching operations, and address translations between a logical block address and a physical block address that are associated with the memory devices 700.

The host system 792 can be a computing device such as a desktop computer, laptop computer, network server, mobile device, or other such computing device that includes a memory and a processing device. The host system 792 can include, or be coupled to, the memory system 790 so that the host system 792 can read data from or write data to the memory system 790. The host system 792 can be coupled to the memory system 790 via a physical host interface (not shown in FIG. 7). As used herein, “coupled to” generally refers to a connection between components, which can be an indirect communicative connection or direct communicative connection (e.g., without intervening components), whether wired or wireless, including connections such as electrical, optical, magnetic, etc. Examples of a physical host interface include, but are not limited to, a serial advanced technology attachment (SATA) interface, a peripheral component interconnect express (PCIe) interface, a universal flash storage (UFS) interface, a universal serial bus (USB) interface, Fibre Channel, Serial Attached SCSI (SAS), etc. The physical host interface can be used to transmit data between the host system 792 and the memory system 790. The host system 792 can further utilize an NVM Express (NVMe) interface to access the memory devices 700 when the memory system 790 is coupled with the host system 792 by the PCIe interface. The physical host interface can provide an interface for passing control, address, data, and other signals between the memory system 790 and the host system 792.

While the example memory system 790 in FIG. 7 has been illustrated as including the controller 791, in another embodiment of the present disclosure, a memory system 790 may not include a controller 791, and can instead rely upon external control (e.g., provided by a processor or controller separate from the memory system 790, such as by host 792 communicating directly with the memory devices 700).

Although the memory system 790 is shown as physically separate from the host 792, in a number of embodiments the memory system 790 can be embedded within the host 792. Alternatively, the memory system 790 can be removable from the host 792.

As used herein, an “apparatus” can refer to various structural components. For example, the computing system 701 shown in FIG. 7 can be considered an apparatus. Alternatively, the host 792, the controller 704, and the memory device 700 might each separately be considered an apparatus.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2. As will be appreciated, elements shown in the various embodiments herein can be added, exchanged, and/or eliminated so as to provide a number of additional embodiments of the present disclosure.

For the purposes of the present disclosure, the phrase “A and/or B” means (A), (B), (A) or (B), or (A and B). For the purposes of the present disclosure, the phrase “A, B, and/or C” means (A), (B), (C), (A and B), (A and C), (B and C), or (A, B and C). Additionally, the phrase “at least one of A and B” means one or more of (A) or one or more of (B), or one or more of (A) and one or more of (B) such that both one or more of (A) and one or more of (B) is not required.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus, comprising:
a memory array comprising a plurality of strings of memory cells, wherein each string of the plurality of strings comprises:
a first group of memory cells coupled to a first group of access lines and corresponding to a first erase block; and
a second group of memory cells coupled to a second group of access lines and corresponding to a second erase block;
wherein the first erase block is configured as a first zone of one or more zones corresponding to a namespace independently of the second erase block.

2. The apparatus of claim 1, wherein the memory array comprises a plurality of blocks, each block of the plurality of blocks is configured as at least two different zones of the namespace.

3. The apparatus of claim 1, wherein at least one zone of the one or more zones corresponds to a block size, wherein memory cells corresponding to more than one erase blocks are configured as the at least one zone.

4. The apparatus of claim 1, wherein the second erase block is configured as a second zone of the one or more zones corresponding to the namespace.

5. The apparatus of claim 1, wherein each zone of the one or more zones comprises at least two erase blocks of the memory array.

6. The apparatus of claim 1, wherein the memory array further comprises a third group of access lines located between the respective first groups of access lines and the respective second groups of access lines.

7. The apparatus of claim 6, wherein the third group of access lines are dummy access lines coupled to memory cells that are not used to store user data.

8. The apparatus of claim 1, wherein the memory array is a three dimensional (3D) array of NAND flash memory cells with the first group of memory cells and the second group of memory cells of each string sharing a common channel region.

9. An apparatus, comprising:
a memory array organized as a namespace and comprising a plurality of first strings of memory cells corresponding at least to a first block, the first block further comprises:
a first erase block configured as a first zone of the namespace and comprising a first group of memory cells coupled to a first group of access lines; and
a second erase block configured as not being part of the first zone and comprising a second group of access lines and corresponding to a second erase block.

10. The apparatus of claim 9, wherein the second erase block is configured as a second zone of the namespace.

11. The apparatus of claim 10, wherein the plurality of first strings corresponds to a first plane of the memory array, and wherein the memory array further comprises:
a plurality of second strings of memory cells corresponding to a second plane of the memory array and a second block, the second block further comprises:
a third erase block configured as the first zone of the namespace and comprising a third group of memory cells coupled to a third group of access lines; and
a fourth erase block configured as the second zone of the namespace and comprising a fourth group of memory cells coupled to a fourth group of access lines;

12. The apparatus of claim 11, wherein the memory array is organized as a plurality of logical units (LUNs), and wherein the first, second, third, and fourth erase blocks are included in a same LUN of the plurality of LUNs.

13. The apparatus of claim 11, further comprising a controller coupled to the memory array, the controller configured to access the first erase block and the third erase block configured as the first zone substantially simultaneously.

14. The apparatus of claim 11, wherein the memory array is organized as a plurality of logical units (LUNs), and wherein the first and third erase blocks are included in different LUNs of the plurality of LUNs.

15. The apparatus of claim 14, wherein the second and fourth erase blocks are included in different LUNs of the plurality of LUNs.

16. The apparatus of claim 14, wherein the second and fourth erase blocks are included in a same LUN of the plurality of LUNs.

17. The apparatus of claim 9, wherein the first group of access lines corresponding to the first erase block is physically separated from the second group of access lines corresponding to the second erase block by a number of access lines coupled to memory cells that are not used to store data.

18. A method, comprising:
configuring a first erase block of a memory array as a first zone of a namespace of the memory array, wherein the first erase block comprises a first group of memory cells coupled to a first group of access lines and at least to a first string of a plurality of strings of the memory array; and
configuring a second erase block of the memory array as a second zone of the namespace of the memory array, wherein the second erase block comprises a second group of memory cells coupled to a second group of access lines and at least to the first string of the plurality of strings of the memory array.

19. The method of claim 18, further comprising:
configuring a third erase block of the memory array as the first zone of the namespace of the memory array, wherein the third erase block comprises a third group of memory cells coupled to a third group of access lines and at least to a second string of the plurality of strings of the memory array; and
accessing the first zone of the namespace by accessing the first and third erase blocks substantially simultaneously.

20. The method of claim 18, further comprising:
configuring a fourth erase block of the memory array as the second zone of the namespace of the memory array, wherein the fourth erase block comprises a fourth group of memory cells coupled to a fourth group of access lines and at least to a second string of the plurality of strings of the memory array; and
accessing the second zone of the namespace by accessing the second and fourth erase blocks substantially simultaneously.
